(19) United States
(12) Patent Application Publication
(10) Pub. No.: US 2025/0112806 A1
(43) Pub. Date: Apr. 3, 2025

(54) FAST CHANNEL EQUALIZATION IN COMMUNICATION CHANNELS USING MACHINE LEARNING TECHNIQUES

(71) Applicant: NVIDIA Corporation, Santa Clara, CA (US)

(72) Inventors: Mohammad Mobin, Saratoga, CA (US); Vishnu Balan, Murphy, TX (US); Johan Jacob Mohr, Copenhagen (DK); Thorkild Franck, Roskilde (DK)

(21) Appl. No.: 18/376,186

(22) Filed: Oct. 3, 2023

(51) Int. Cl. H04L 25/03; H04B 17/21; H04B 17/391

(52) U.S. Cl. CPC H04L 25/03057; H04B 17/21; H04B 17/3913; H04L 2025/03617

(57) ABSTRACT

Disclosed are apparatuses, systems, and techniques for deploying and training machine learning models for fast and efficient equalization of signals transmitted over communication channels. In one embodiment, the techniques include processing, using first model(s), a digital representation of a received (RX), via a communication channel, signal to obtain channel loss metrics representative of a difference between the RX signal and a transmitted (TX) signal. The techniques further include obtaining a first set of equalization (EQ) parameter(s), and iteratively obtaining a second set of EQ parameter(s). The techniques further include configuring, using the second set of the EQ parameters, one or more EQ circuits to equalize at least one of the RX signal, the TX signal, or a channel signal.

### TECHNICAL FIELD

At least one embodiment pertains to processing resources used to facilitate digital communications in computing systems and networks. For example, at least one embodiment pertains to using machine learning-based equalization techniques for improving speed and throughput of communication channels.

### BACKGROUND

Communication lines, such as wires, coaxial cables, optical fibers, and the like, can transmit a series of symbols that are digitally encoded, e.g., as sequences of bits 0 and 1, using an analog modulated signal S_{T}(t), e.g., a current or voltage signal. Because of the presence of dispersion (dependence of the impedance of the communication channel on frequency f), different Fourier harmonics of the transmitted signal, S_{T}(f), attenuate to a different degree, a signal received by a receiving (RX) device, S_{R}(f)=(1−L(f))S_{T}(f), experiences a frequency-dependent loss L(f). The loss L(f) is typically smaller at lower frequencies f and increases at higher frequencies. The loss L(f) includes both a change (e.g., reduction) in amplitude and a phase shift. The loss-distorted RX signal S_{R}(f) converted back to the time domain S_{R}(t) results in a sequence of bits that can be different from the sequence transmitted by the transmitting (TX) device. To recover the correct transmitted information, various equalization techniques are usually deployed to amplify the received signal, S_{R}(f)→A(f)S_{R}(f)≈S_{T}(f), by a frequency-dependent amplification factor A(f) that compensates for the incurred loss, A(f)≈[1−L(f)]⁻¹. Reducing a number of incorrectly received symbols and, therefore, improving the throughput of the communication channel depends on how accurately this loss-compensation is performed.

### BRIEF DESCRIPTION OF DRAWINGS

FIG. 1 is a block diagram of an example system capable of implementing equalization techniques that use machine learning for fast and efficient equalization of signals in communication channels, according to at least one embodiment;

FIG. 2 illustrates schematically a data flow in an example equalization module that deploys machine learning for fast and efficient equalization of signals transmitted over communication channels, according to at least one embodiment;

FIG. 3A illustrates schematically example training operations of one or more machine learning models that may be deployed for fast and efficient equalization of signals transmitted over communication channels, according to at least one embodiment;

FIG. 3B illustrates schematically another example training operations of a unified machine learning models that may be deployed for fast and efficient equalization of signals transmitted over communication channels, according to at least one embodiment;

FIG. 4A illustrates schematically an example fine-tuning of equalization parameters, according to at least one embodiment;

FIG. 4B is a schematic diagram illustrating a difference between an estimated loss metric (vertical axis) and an actual loss (horizontal axis) metric for a set of training channels, according to at least one embodiment;

FIG. 5 is a flow diagram of an example method of deploying machine learning models for fast and efficient equalization of signals transmitted over communication channels, according to at least one embodiment;

FIG. 6 is a flow diagram of an example method of training machine learning models for fast and efficient equalization of signals transmitted over communication channels, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment.

### DETAILED DESCRIPTION

Modern communication channels increasingly support high-speed and high-volume data transmission. Data may be transferred between different processing devices, between different components of an individual computer, between different local computers, between computers connected to a network, and/or the like. Increasing the throughput of a communication channel is achieved by packing more bits into a given time interval. According to the Nyquist theorem, to support transmission with a target bit rate R, the communication channel has to correctly transmit frequencies up to at least the Nyquist frequency, which is double the target bit rate f_{N}=2R. Correspondingly, higher throughputs require that harmonics S_{R}(f) within an increasingly wide range of frequencies be accurately equalized. Increasing complexity of equalization also implies that the equalization time is becoming longer. On the other hand, many communication standards impose an upper limit on the equalization time. As a result, requirements of many modern data communication applications are at the limit or even beyond the limit of the existing equalization methods.

Aspects and embodiments of the instant disclosure address these and other challenges of the existing technology by providing for methods and systems that perform fast and efficient equalization of analog signals transmitted via communication channels (lines) using machine learning techniques. In some embodiments, received (RX) signals may be digitized and processed by a one or more trained machine learning models (MLMs) that output an initial set of equalization parameters, which may include amplification gains A(fᵢ) for a set of frequencies (or a set of frequency ranges) {fᵢ}=f₁, f₂ . . . f_{M} that may range from low (near-DC) frequencies to the Nyquist frequency f_{M}≈f_{N} (or even above the Nyquist frequency f_{M}>f_{N}). The set of equalization parameters may include a direct current (DC) gain, low frequency (LF) gain, medium frequency (MF) gain, high frequency (HF) gain, a LF pole, a MF pole, a CDR (clock and data recovery/structure) phase, and/or TX filter parameters, and/or the like.

The one or more MLMs may include a loss detection model and an equalization model. In some embodiments, the loss detection model may be (or include) a neural network (NN) model, e.g., a convolutional NN (CNN) model, dense neural network (DNN) model and/or other suitable neural network models. The NN model may output an estimated channel loss, a signal swing estimate, and/or the similar metrics. The estimated channel loss metrics may be obtained for one or more frequencies, e.g., the Nyquist frequency, f_{N}, one-half of the Nyquist frequency, f_{N}/2, or some other reference frequencies. The loss estimate outputs of the NN model (or other loss detection model) may be used as an input into the equalization model that generates an initial set of equalization (EQ) parameters to be implemented on EQ circuits of RX and/or TX devices. The signal swing estimate may be used to amplify or attenuate the signal to optimize the signal dynamic range inside the receiver signal data path.

In some embodiments, instead of the neural NN model, the loss detection model may be (or include) a statistical model that predicts (estimates) channel losses and/or other metrics based on analysis of various statistical characteristics of the received signals, e.g., received signal digitized using an analog-digital converter (ADC). In one example embodiment, a ratio of a standard deviation of the ADC output to a range of this output or a similar statistical characteristic may be computed and used for estimation of channel losses.

The equalization model may then use the output of the loss detection model (the NN-based model or statistics-based model) to generate the initial set of EQ parameters. The equalization model may be a trained MLM, a lookup table, an equation, or some other model. The initial set of EQ parameters may be used by an equalizer on the RX device (and/or TX device) while additional fine-tuning of the equalization parameters takes place. In some embodiments, the fine-tuning may be performed iteratively, e.g., using one or more techniques of iterative searching, such as stochastic hill climbing, grid search, periodic adaptation, genetic mutations, and/or the like. As a result of the fine-tuning, the initial set of EQ parameters is replaced with a modified (e.g., final) set of EQ parameters that more accurately equalizes the propagation in the communication channel or account for temporal variations of changing channel conditions.

Training of the loss detection model(s) can be performed using a training set of multiple communication channels (training channels), which may differ by type (e.g., coaxial cables, wire cables, etc.), material (e.g., copper, silver, etc.), length, cross section, and/or other characteristics. Losses in the training channels may be measured directly for known signals transmitted through the channels and then used as ground truth to train the loss prediction model(s) using various learning techniques, e.g., loss functions, backpropagation, gradient descent, and/or the like.

The advantages of the disclosed techniques include but are not limited to improving speed and efficiency of equalization in communication channels. For example, the two-stage processing described above leads to faster equalization since the first stage is capable of generating an initial set of equalization parameters very quickly. Furthermore, since the initial set of EQ parameters, generated by trained models, represents a good approximation of the final set of EQ parameters, the second (fine-tuning) stage takes relatively short time to discover these parameters as the fine-tuning algorithms may converge much more quickly than in conventional techniques.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems for performing one or more generative AI operations, systems implemented at least partially using cloud computing resources, and/or other types of systems.

### System Architecture

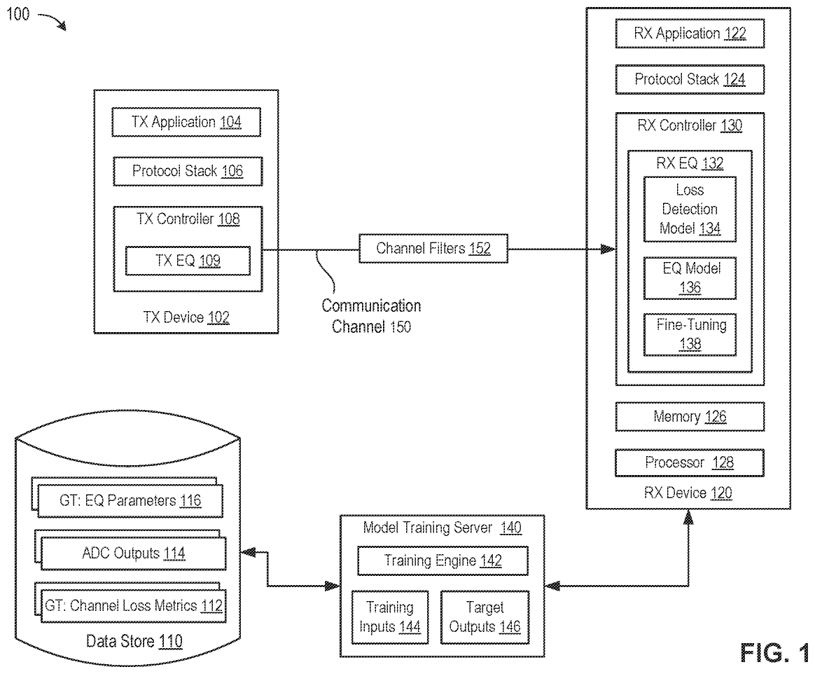

FIG. 1 is a block diagram of an example system 100 capable of implementing equalization techniques that use machine learning for fast and efficient equalization of signals in communication channels, according to at least one embodiment. As depicted in FIG. 1, system 100 may include multiple computing devices, including a transmitting (TX) device 102 connected via a communication channel 150 to a receiving (RX) device 120. TX device 102 and/or RX device 120 may be (or include) an integrated circuit implemented on a single substrate (or microchip) that supports multiple computer components. More specifically, RX device 120 (and similarly, TX device 102, not shown for conciseness) may include a number of hardware resources, including memory 126 and one or more processors, such as central processing units, graphics processing units, parallel processing units (PPUs), data processing units (DPUs), hardware accelerators, and/or various other components that are not explicitly illustrated in FIG. 1.

In some embodiments, TX device 102 and RX device 120 may be remote to each other, connected by communication channel 150 associated with a network. The network may be a public network (e.g., the Internet), a private network (e.g., a local area network (LAN), or wide area network (WAN)), a wireless network, a personal area network (PAN), a mesh network, and/or any combination thereof. In some embodiments, TX device 102 and RX device 120 may be local to each other with communication channel 150 being associated with a high-speed bus, e.g., InfiniBand, Peripheral Component Interconnect (PCI), or some other connection. In some embodiments, communication channel 150 may include an Ethernet channel, a Fibre Channel, a Fibre Channel over Ethernet (FCOE), and/or the like.

In some embodiments, TX device 102 and RX device 120 may support one or more applications, including real-time data streaming and/or processing applications. In some embodiments, TX application 104 may be executed on TX device 102 independently from or in conjunction with RX application 122 on RX device 120. For example, TX application 104 may be a video streaming application or a gaming cloud application and RX application 122 may be a video displaying application or a gaming console application. In some embodiments, TX application 104 and/or RX application 122 may be or include an autonomous driving application.

TX application 104 may generate a stream of data that may be processed using a suitable protocol stack 106 for data transmission, e.g., an MIPI CSI transfer protocol stack. For example, protocol stack 106 may include hardware components and/or firmware modules implementing a physical layer, a low-level protocol layer, a pixel-to-byte conversion layer, an application layer, and the like. In some embodiments, protocol stack 106 may support multiple selectable data transmission rates. Data processed by protocol stack 106 may be provided to TX controller 108 for passing to RX controller 130 of RX device 120 via communication channel 150.

In some embodiments, TX controller 108 and RX controller 130 may implement a Serializer/Deserializer (SerDes), e.g., with TX controller 108 performing serialization of parallel inputs received from TX application 104 (e.g., Parallel-In-Serial-Out, or PISO) and RX controller 130 performing deserialization of the stream of data received by RX controller (e.g., Serial-In-Parallel-Out, or SIPO) and providing multiple parallel inputs to RX application 122. Although, for brevity and conciseness, data transmission is often described as occurring from TX device 102 to RX device 120, it should be understood that system 100 may support two-way data transmission. For example, during a first plurality of times, RX device 120 receives data from TX device 102, while during a second plurality of times, RX device 120 transmits data to TX device 102. Protocol stack 124 may facilitate data transmission and/or reception on RX device 120 and/or TX device 102, e.g., generating frames, packeting frames into packets, depacketizing packets into frames, and/or the like.

An equalizer operating on RX device (RX EQ) 132 may process signals received from TX controller 108 to undo distortion caused by transmission of the signal over communication channel 150. For example, in some embodiments, RX EQ 132 may perform equalization that attenuates low-frequency signal components, amplifies frequency components around the Nyquist frequency, and filters off high-frequency noise above the Nyquist frequency. In some embodiments, equalization performed by RX EQ 132 may include continuous time linear equalization (CTLE), feed-forward equalization (FFE), decision feedback equalization (DFE), or some other type of equalization, or a combination thereof. Operations RX EQ 132 may be controlled by setting one or more EQ parameters, which may include gains at one or more frequencies or frequency ranges, pole frequencies in one or more frequency ranges, and/or other similar parameters. RX EQ 132 may deploy one or more models to determine EQ parameters. The models may include a loss detection model 134 and an equalization model 136. Loss detection model 134 may estimate channel losses that occur in communication channel 150. In some embodiments, loss detection model 134 may be a NN model, a statistical model, or a combination thereof. Equalization model 136 may use an output of loss detection model 134 to generate an initial set of EQ parameters. The initial set of EQ parameters may be used to configure RX EQ 132 to perform initial equalization of signals received over communication channel 150 while fine-tuning module 138 performs additional iterative fine-tuning to replace the initial set of EQ parameters with a modified (or final) set of EQ parameters.

Training of various models deployed by RX EQ 132 may be performed using training data stored in data store 110. The training data may include channel loss metrics 112 collected for multiple communication channels (also referred to as training channels herein). More specifically, an individual training channel may be used for transmitting one or more test signals, e.g., signals with known frequency spectra S_{T}(f). Signals S_{R}(f), received via a training channel may be processed by an ADC of the receiving device. ADC outputs 114 may be stored, e.g., in data store 110. ADC outputs 114 may be used as training inputs during training of the models and actual (measured) channel loss metrics 112 may be used as target outputs. Channel loss metrics 112 may include, e.g., a ratio of the two signals, S_{T}(f)/S_{R}(f), a difference of the two signals S_{T}(f)−S_{R}(f), a relative difference of the two signals, [S_{T}(f)−S_{R}(f)]/S_{T}(f), and/or some other suitable metric indicative of the distortion incurred by the transmitted signal during propagation in the training channel. Channel loss metrics 112 may characterize both an amplitude of distortion and a phase of distortion.

Data store 110 may be accessible to a model training server 140 that performs training of various models, e.g., loss detection model 134, equalization model 136, and/or the like. To perform training, model training server 140 may deploy a training engine 142 that assembles and uses training data, which may include training inputs 144 (e.g., ADC outputs 114) and corresponding target outputs 146 (e.g., channel loss metrics 112). Target outputs 146 (ground truth) correspond to correct (e.g., measured) losses caused by training channels to test signals transmitted therethrough. Training engine 142 may find patterns in the training data that map training inputs 144 to target outputs 146 and train loss detection model 134, equalization model 136, and/or other applicable models to capture these patterns.

Data store 110 may be hosted by one or more storage devices, such as main memory, magnetic or optical storage disks, tapes, or hard drives, network-attached storage (NAS), storage area network (SAN), and so forth. Although depicted as separate from model training server 140 or other components of system 100, in at least one embodiment, data store 110 may be a part of model training server 140. In at least some embodiments, data store 110 may be a network-attached file server. In other embodiments, data store 110 may be some other type of persistent storage, such as an object-oriented database, a relational database, and so forth, that may be hosted by one or more other machines coupled to other components of system 100 via a suitable network.

Some or all of the TX device 102, RX device 120, data store 110, model training server 140, and/or other devices of system 100 may be implemented on desktop computers, laptop computers, smartphones, tablet computers, rackmount servers, computing device that access a remote server, computing devices that utilize a virtualized computing environment, gaming consoles, wearable computers, smart TV, and/or any combination thereof.

Some or all of the TX device 102, RX device 120, data store 110, model training server 140, and/or other devices of system 100 may use any number of processors, such as central processing units (CPUs), graphics processing units (GPUs), parallel processing units (PPUs), data processing units (DPUs), accelerators, and/or other suitable processing devices capable of performing the techniques described herein. The processors may be communicatively coupled to any number of memory devices. The CPUs and/or GPUs (or other processing devices) may support any number of virtual CPUs and/or virtual GPUs. For example, a GPU may include multiple cores, each core being capable of executing multiple GPU threads. Individual cores may run multiple threads concurrently (e.g., in parallel). In at least one embodiment, threads may have access to registers. Some or all cores may include a scheduler to distribute computational tasks and processes among different threads of the respective core. A dispatch unit may implement scheduled tasks on appropriate threads using various private registers and shared registers. In at least one embodiment, GPU(s) may have a (high-speed) cache, access to which may be shared by multiple cores. Furthermore, GPU(s) may include a GPU memory to store intermediate and/or final results (outputs) of various computations performed by the GPU. In some embodiments, various components of system 100 may include network controllers, peripheral devices (e.g., gaming consoles, microphones for capturing sounds, printers), and the like.

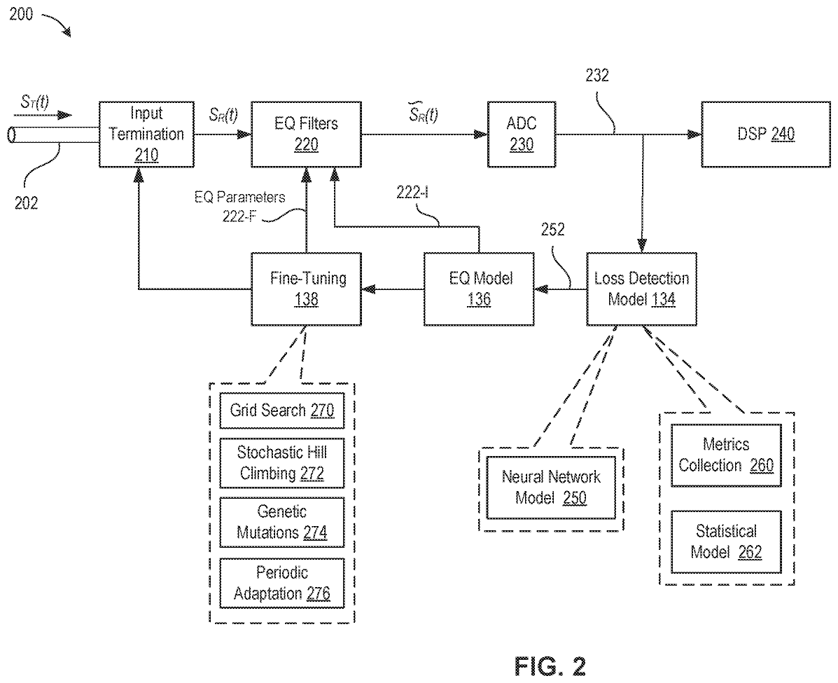

FIG. 2 illustrates schematically a data flow 200 in an example equalization module that deploys machine learning for fast and efficient equalization of signals transmitted over communication channels, according to at least one embodiment. Operations of data flow 200 may be performed by RX device 120 of FIG. 1. As depicted in FIG. 2, an analog signal S_{T}(t) may be inputted (e.g., by TX device 102 of FIG. 1) into communication channel 202. A distorted signal S_{R}(t) may be received by RX device from communication channel 202. Data flow 200 illustrated in FIG. 2 may be configured to minimize or reduce the difference S_{T}(t)−S_{R}(t). Signal delivered over communication channel 202 may be received at an input termination 210. Input termination 210 may include one or more circuits configured to minimize reflections of the received signal back into communication channel 202, e.g., by matching an impedance of input termination 210 to the characteristic impedance of communication channel 202.

EQ filters 220 may modify spectral (frequency) content of the received signal S_{R}(t) to bring the spectral content of the modified signal S_{R}(t) close to that of transmitted signal S_{T}(t), e.g., by attenuating low-frequency signal components of S_{R}(f), amplifying higher-frequency components within the 0.5-1 of the Nyquist frequency f_{N}, filtering high-frequency noise above the Nyquist frequency f_{N}, and/or using other operations. EQ filters 220 may be configured responsive to EQ parameters 222 set as disclosed in further detail below. At the start of equalization, e.g., when a new signal S_{R}(f) is received via communication channel 202, EQ filters 220 may be configured using preset (e.g., default) equalization parameters.

Signal \tilde{S}_{R}(t) received by input termination 210 and equalized by EQ filters 220 may be digitized (sampled) by analog-to-digital converter (ADC) 230 according to a specific sampling rate that corresponds to a rate of digital signal transmission (e.g., as set by TX application 104 in FIG. 1). Sampled ADC outputs 232 may be provided to digital signal processing (DSP) 240 and may also be provided to a feedback equalization loop that includes loss detection model 134, EQ model 136, fine-tuning 138, and/or other suitable modules and components not explicitly shown in FIG. 2.

DSP 240 may perform various operations on ADC outputs 232, including but not limited performing error-correction, depacketizing, authentication, decryption, storing ADC outputs 232 in memory, and/or processing ADC outputs 232 according to operations specified by a target recipient (e.g., RX application 122 in FIG. 1) of the data encoded in ADC outputs 232. DSP 240 may include any suitable collection of software/firmware executable codes, libraries, and various other resources, which may be stored in memory (e.g., memory 126 in FIG. 1) and executed by one or more processors (e.g., processor 128 in FIG. 1), including but not limited to one or more CPUs, GPUs, PPUs, field-programmable gate arrays (FPGAs), application-specific integrated circuits (ASICs), and/or any other processing device, or a combination thereof. For example, if ADC outputs 232 include a series of video frames, DSP 240 may correct errors in the ADC outputs, depacketize, decode, and authenticate received frames, provide the frames to a display of a streaming application, gaming application, and/or the like.

Additionally, sampled ADC outputs 232 may be processed by loss detection model 134. In some embodiments, loss detection model may be (or include) a neural network (NN) model 250, e.g., a deep neural network having one or more hidden layers, such as a convolutional NN, a recurrent NN, a fully-connected (dense) NN, a long short-term memory (LSTM) NN, an attention-based NN (including but not limited to a transformer NN), and/or any other networks or a combination thereof. For example, NN model 250 may include a convolutional subnetwork (backbone) and one or more classification heads having at least one fully-connected neural layer. Various neurons of NN model 250 may receive inputs from other neurons or from an external source (e.g., ADC 230) and may produce an output by computing a sum of weighted inputs and a bias value and subjecting the processing the computed sum using an activation function, e.g., a rectified linear unit activation function (ReLU), a sigmoid activation function, a hyperbolic tangent activation function, and/or the like. In one illustrative example, weights and biases of NN model 250 may initially be assigned random values that are subsequently modified (learned) during training.

In some embodiments, the inputs into NN model 250 may include one or more ADC outputs 232, herein also denoted as O(tⱼ). In some embodiments, a sliding window of n outputs O(t₁), O(t₂), . . . O(tₙ), e.g., n most recent samples collected by ADC 230, may be inputted at once into NN model 250 (e.g., via separate inputs of a first layer of the network). The number n may be set as part of NN model 250 architecture. In some embodiments, once the next output O(tₙ₊₁) is sampled by ADC 230, the input into NN model 250 may be updated, e.g., with the oldest output O(t₁) dropped and new output O(tₙ₊₁) added, such that the new input into NN model 250 includes O(t₂), O(t₃), . . . O(tₙ₊₁). In other embodiments, instead of processing the sliding window of n ADC outputs 232, NN model 250 may wait for the next n ADC outputs 232, e.g., O(tₙ₊₁), O(tₙ₊₂), . . . O(t₂n), to be collected prior to processing these next n ADC outputs. In some embodiments, e.g., in the instances where NN model 250 includes a recurrent NN, an LSTM network, a memory-based NN, and/or the like, ADC outputs 232, O(t₁), O(t₂), . . . O(tₙ), may be inputted into NN model 250 sequentially, e.g., one ADC output O(tⱼ), at a time, with O(t₂) being fed into NN model 250 after O(t₁), and so on.

NN model 250 may output one or more channel loss metrics 252 characterizing losses L(f₁), . . . L(fₘ) of communication channel 202 at one or more reference frequencies f₁, . . . fₘ, distributed across a target range of frequencies, e.g., from very low frequencies (near-DC) to the Nyquist frequency or even more. In some embodiments, a single loss L(f₁) may be outputted for a single reference frequency, f₁, which may be the Nyquist frequency (e.g., for Partial Response-0 systems), half of the Nyquist frequency (e.g., for Partial Response-1 systems), or some other reference frequency that is defined in reference to the Nyquist frequency (e.g., as a fraction of the Nyquist frequency).

In some embodiments, instead of (or in addition to) using neural NN model 250, loss detection model 134 may include a statistical model 262 that generates channel loss metrics 252 (e.g., L(f₁), . . . L(fₘ) or other similar metrics) based on analysis of various statistical characteristics S₁, . . . Sₚ of ADC outputs 232 O(tⱼ). More specifically, a metrics collection module 260 may analyze a temporal distribution of the ADC outputs O(tⱼ) and collect various statistical characteristics of this temporal distribution, e.g., a mean ADC output, a range of ADC outputs, a standard deviation of ADC outputs, and/or other similar statistical characteristics (e.g., skewness, kurtosis, two-time correlations, etc.) to be used as s a proxy for the channel loss metrics 252. The statistical model 262 may then map statistical characteristics S₁, . . . Sₚ to channel loss metrics 252, L(f₁), . . . L(fₘ). In some embodiments, the mapping S₁, . . . Sₚ→L(f₁), . . . L(fₘ) may be performed using a mapping table, a regression model, a decision tree classifier, a support vector machine (SVM), a boosting (e.g., gradient boosting, adaptive boosting, etc.) model, a neural network model, or some other suitable MLM.

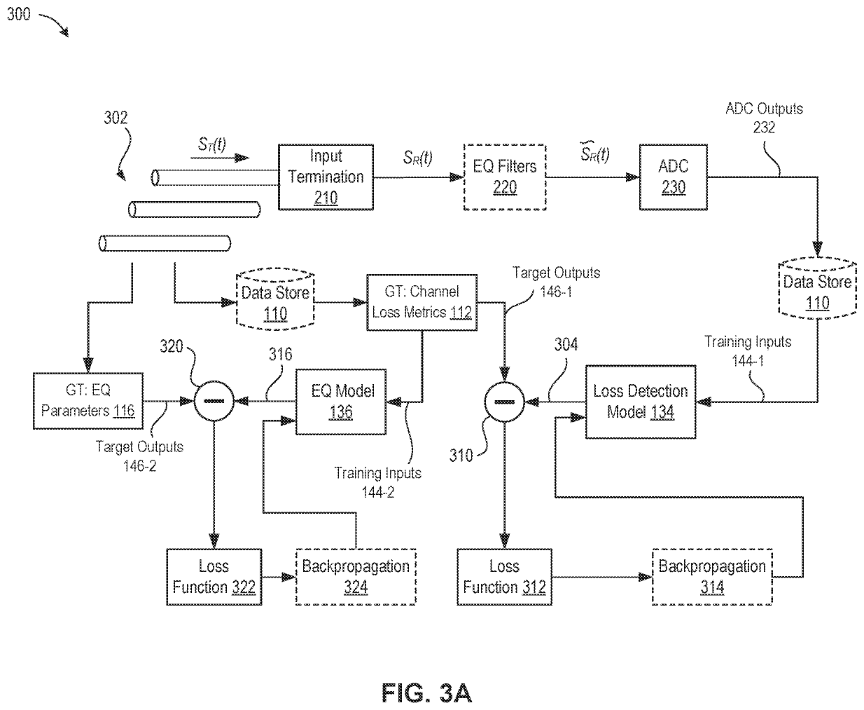

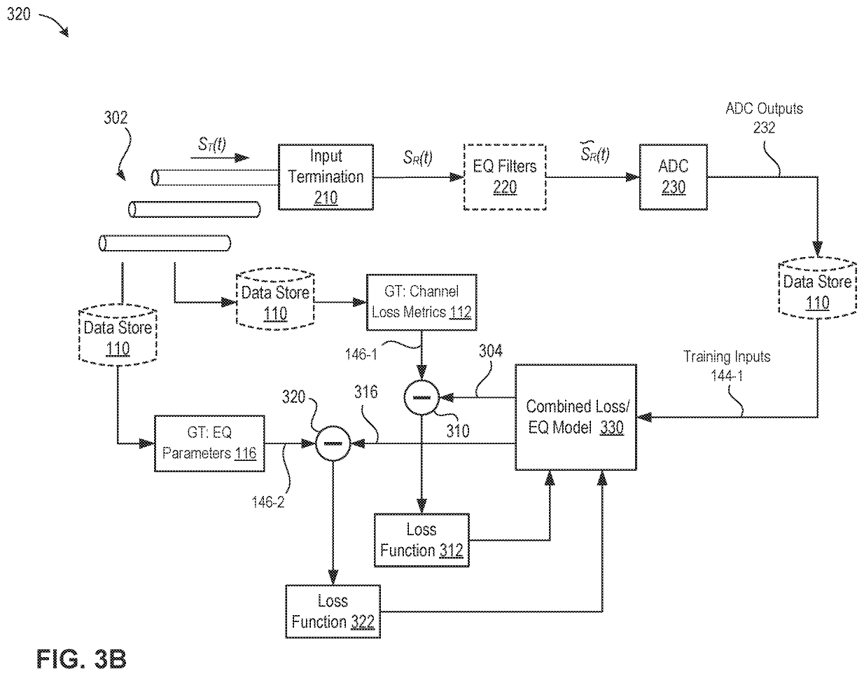

In one specific example non-limiting embodiment, a ratio r=σ[ADC]/(ADC_{MAX}−ADC_{MIN}) of the standard deviation σ[ADC] of the ADC outputs to the range ADC_{MAX}-ADC_{MIN} of these outputs may be used as one such statistical characteristic. Our experiments, conducted on a number of communication channels, demonstrate a significant correlation between the ratio R and the channel loss metrics L(fᵢ), with higher values of the ratio r indicative of lower losses L(fᵢ) and lower values of the ratio R indicative of higher losses L(fᵢ). Training of statistical model 262, e.g., performed as disclosed below in conjunction with FIG. 3A and/or FIG. 3B, may reveal quantitative relationship between this ratio r and the amount of losses in communication channels, r=>L(fⱼ).

Channel loss metrics 252, obtained for one or more frequencies fⱼ by loss detection model 134, may be input into EQ model 136 trained to generate an initial set of EQ parameters 222. EQ model 136 may be a trained MLM, a lookup table, an regression formula, equation, or some other model. EQ model 136 may include a mapping table, a regression model, a decision tree classifier, an SVM, a boosting model, a neural network model, or some other MLM. In some embodiments, EQ model 136 may be a model combined (e.g., trained together) with one or more other models, e.g., NN model 250 or statistical model 262. The initial set of EQ parameters 222-I may include one or more parameters, P₁, P₂, . . . P_{N}, that serve as an optimal equalization preset for EQ filters 220 and may be deployed (as illustrated with the dashed arrow in FIG. 2) at the start of equalization. In one example, initial set of EQ parameters 222-I may include direct current (DC) gain, low frequency (LF) gain, medium frequency (MF) gain, high frequency (HF) gain, a LF pole, a MF pole, a CDR (clock and data recovery/structure) phase, impedance Z(f) of input termination 210, and/or the like. Although not shown explicitly in FIG. 2, initial set of EQ parameters 222-I may also include one or more parameters for filters of TX EQ 109 of the transmitting device (with reference to FIG. 1) to implement pre-equalization of the transmitted signal S(t).

The initial set of EQ parameters may be used by an equalizer on the RX device (and/or, in some embodiments, TX device) while additional fine-tuning 138 of the EQ parameters is occurring. In some embodiments, fine-tuning 138 may be performed iteratively, e.g., using one or more techniques of iterative searching in the N-dimensional space of EQ parameters P₁, P₂, . . . P_{N}. During each iteration, one or more EQ parameters may be changed, Pⱼ→Pⱼ+ΔPⱼ, and fine-tuning 138 may track the resulting changes in suitable channel quality metrics indicative of the quality of the RX signal. Such channel quality metrics may include, but are not limited to, a signal-to-noise ratio of the RX signal, of the data carried by the RX signal, a mean-squared error, one or more metrics associated with a figure of merit (FOM) for an eye diagram (pattern). Such FOM metrics may include an eye height, width, amplitude, opening factor, rise time, fall time, jitter, level zero, level one, bit error rate (BER), level mean, and/or other suitable FOM metrics, and/or a combination (e.g., weighted combination) of suitable FOM metrics.

In some implementations, during various each iteration of fine-tuning 138, responsive to changes of one or more EQ parameters, e.g., due to changes in temperature, humidity, and/or other conditions, which in turn alter channel loss characteristics, channel loss metrics 252, L(fₖ)→L(fₖ)+ΔL(fₖ), may be detected by loss detection model 134. Finding final EQ parameters 222-F may then amount to minimizing individual loss metrics, L(fₖ), and/or some global loss function Loss (L(f₁), . . . L(fₘ)), which may include a simple average of individual loss metrics L(f₁), . . . L(fₘ), a weighted average of individual loss metrics L(f₁), . . . L(fₘ), or any other function of the individual loss metrics.

As a result of fine-tuning 138, initial set of EQ parameters 222-I is replaced with a final set of EQ parameters 222-F that more accurately equalizes the propagation in the communication channel.

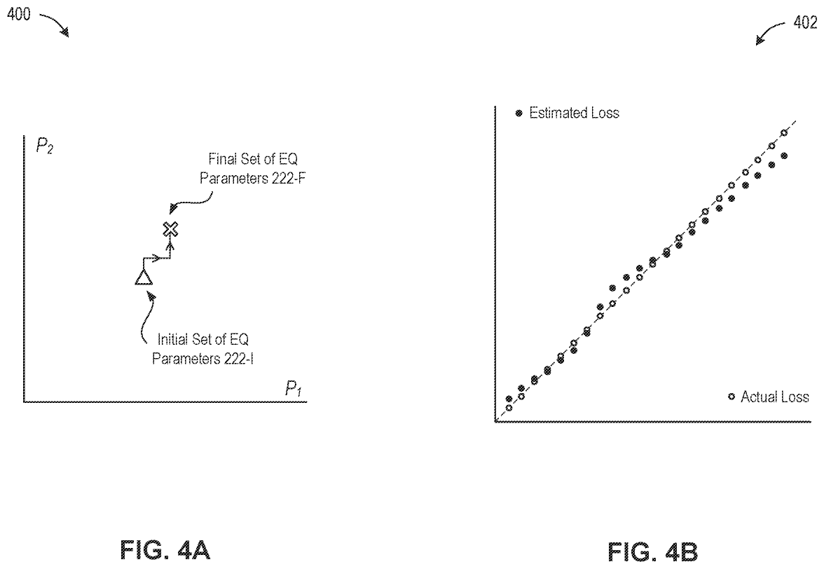

In some embodiments, fine-tuning 138 may deploy various techniques, such as grid search 270, stochastic hill climbing 272, genetic mutations 274, and/or other suitable techniques. FIG. 4A illustrates schematically an example fine-tuning 400 of equalization parameters, according to at least one embodiment. Fine-tuning 400 begins at an initial set of EQ parameters 222-I (depicted schematically with the triangle) and iteratively reaches a final set of EQ parameters 222-F (depicted schematically with the cross). For ease of viewing, fine-tuning 400 is shown for a set of two EQ parameters P₁ and P₂, although the number of EQ parameters need not be limited.

For example, grid search 270 may include a coarse grid search and a fine grid search. During the coarse grid search, some EQ parameters P₁, P₂, . . . P_{N} may be maintained (e.g., at initial values) while other EQ parameters P₁, P₂, . . . P_{N} are searched. After the coarse grid search selects a coarse value of one or more EQ parameters P₁, P₂, . . . P_{N} to ensure minimum of the loss metrics, grid search 270 may apply a second-fine-grid search on a smaller scale around the selected values of coarse EQ parameters for potentially higher performing EQ parameters.

Stochastic hill climbing 272 may include applying hill climbing adjustments to seed values (e.g., initial set of EQ parameters 222-I) to achieve a local minimum of the loss metrics with respect to variations of individual EQ parameters P₁, P₂, . . . P_{N}. For example, during a given round of hill climbing 272, a random order of EQ parameters P₃, P₁, P₄, P₂, etc., may be selected. A first selected parameter, e.g., P₃, may be adjusted until a local minimum of the loss metrics is reached. This process may be repeated for subsequent parameters in the selected order, e.g., P₁, P₄, P₂, etc. until all EQ parameters have been adjusted. In some embodiments of stochastic hill climbing 272, more than one EQ parameter Pⱼ may be adjusted concurrently during individual rounds of hill climbing.

Genetic mutations 274 may include random displacements of EQ parameters P₁, P₂, . . . P_{N} within a predetermined displacement range of parameters to produce one or more sets of modified EQ parameters that include mutations of initial EQ parameters 222-I. In some embodiments, different rounds of genetic mutations 274 may include applying different randomly selected displacements, e.g., up to a maximum displacement value, to the EQ parameters. Various EQ parameters may be displaced both in the positive and the negative direction by an amount given by the randomly selected, for a given round, random displacement. Additional rounds of genetic mutations 274 may then be applied to the same initial EQ parameters 222-I or the EQ parameters mutated by previous round(s) of genetic mutations 274.

In addition, in some embodiments, some of the final EQ parameters 222-F (and initial set of EQ parameters 222-I) may be transmitted to the TX device so that those EQ parameters can be used to set up or adjust setting of the one or more pre-equalization filters of the TX device. In some embodiments, after the EQ parameters have been generated and/or updated using grid search 270, stochastic hill climbing 272, and/or genetic mutations 274, the fine-tuning 138 may include periodic adaptation 276 of one or more EQ parameters, e.g., to account for instances of changing conditions (e.g., changing voltage, temperature, and/or other environmental condition) that lead to changing channel losses.

During periodic adaptation 276, small incremental adjustments to individual EQ parameters P₁, P₂, . . . P_{N} may be applied to minimize the loss metrics. For example, periodic adaptation 276 may include adjusting one or more EQ parameters by a small increment (a unit step) to retest the vicinity of the respective EQ parameters for potential improvements to the loss metrics. Periodic adaptation 276 may include positive unit step adjustments as well as negative unit step adjustments of the parameter's values. When a given adjustment results in lower loss metrics, periodic adaptation 276 may iteratively proceed in the direction of the adjustment (e.g., with the same unit steps) until the loss metrics are locally minimized with respect to the parameter.

FIG. 3A illustrates schematically example training operations 300 of one or more machine learning models that may be deployed for fast and efficient equalization of signals transmitted over communication channels, according to at least one embodiment. Training operations 300 may be performed by training engine 142 of FIG. 1 and may be used to train loss detection model 134 and/or EQ model 136, and/or other models deployed by the equalization components of any suitable computing device (e.g., by RX device 120 of FIG. 1).

Training operations 300 may involve using a set of training communication channels 302, which may differ by type (e.g., coaxial cables, wire cables, optical fibers, etc.), material (e.g., copper, silver, etc.), length, thickness, and/or other characteristics. In some embodiments, a single training channel 302 may be used for multiple training sessions that may differ by specific environmental conditions applied to the channel (e.g., temperature, voltage, etc.), rate of data transmission through the channel, and/or the like.

During training, similarly to operations described in conjunction with FIG. 2, an analog signal S_{T}(t) may be transmitted by some TX device and received as a distorted signal S_{R}(t). In some embodiments, the received signal S_{R}(t) may be equalized (\tilde{S}_{R}(t)≠S_{R}(t)) using EQ filters 220. In some embodiments, EQ filters 220 may be configured using the same preset (e.g., default) equalization parameters as will be used during inference stage (as disclosed in conjunction with FIG. 2 above). In some embodiments, the received signal S_{R}(t) need not be equalized (\tilde{S}_{R}(t)=S_{R}(t)). A spectral analyzer (not depicted in FIG. 3A) may be used to determine a spectral representation S_{R}(f) of the received signal. The received signal may be digitized (sampled) by ADC 230 to generate sampled ADC outputs 232.

ADC outputs 232 may be used as inputs into loss detection model 134. In some embodiments, ADC outputs 232 may first be collected and stored in a suitable data store (e.g., data store 110 in FIG. 1) and subsequently used as training data. Sampled ADC outputs 232 may be used as training inputs 144-1 in training of loss detection model 134, which may include a NN model 250, a statistical model 262 (with reference to FIG. 2), in some examples. When loss detection model 134 includes NN model 250, inputs into NN model may include a vector of n such ADC outputs O(t₁), O(t₂), . . . O(tₙ). Loss detection model 134 may output one or more estimated channel loss metrics 304 (training outputs) characterizing losses L(f₁), . . . L(fₘ) of training channel 302 at one or more reference frequencies f₁, . . . fₘ, e.g., ranging from very low frequencies (near-DC) to the Nyquist frequency or even more. In some embodiments, a single loss L(f₁) may be estimated for a single reference frequency, which may be the Nyquist frequency f_{N}, or some fraction the Nyquist frequency, e.g., f_{N}/2, or some other reference frequency.

Actual channel loss metrics 112, e.g., measured using spectral analysis of received signals S_{R}(t) (and, optionally, stored in data store 110) may be used as target outputs 146-1 (ground truth, or GT) for training of the loss detection model 134. More specifically, a difference 310 between estimated channel loss metrics 304 and GT channel loss metrics 112 may be determined and evaluated using a suitable loss function, e.g., a mean squared difference, or MSD, loss function 312, or some other loss function. The computed value of loss function 322 may be used to adjust parameters of loss detection model 134 in a way that reduces the value of loss function 312. In the instances of an NN model used as loss detection model 134, various techniques of backpropagation 314 and gradient descent may be used. In the instances of a statistical model (e.g., statistical model 262) used as part of a regression-based loss detection model 134, various regression parameters may be adjusted to modify predictions of loss detection model 134 in such a way that the value of loss function 312 is reduced. Other types of detection model 134 (e.g., lookup tables, decision trees, SVMs, boosting classifiers, etc.) may similarly be trained using loss function 312. FIG. 4B is a schematic diagram 402 illustrating a difference between an estimated loss metric (vertical axis) and an actual loss (horizontal axis) metric for a set of training channels, according to at least one embodiment. For simplicity of viewing, a single loss metric is illustrated in FIG. 4B. Open circles in FIG. 4B depict an actual loss metric (e.g., one of GT channel loss metrics 112) and black circles depict an estimated, by loss detection model 134, loss metric (e.g., one of estimated channel loss metrics 304). Each vertically-positioned pair of open/black circles corresponds to a different training channel 302 (or to the same training channel 302 deployed under different conditions). During training of loss detection model 134, distances between the open circles and the black circles are reduced until a target accuracy (maximum distance) is reached.

Training of equalization model 136 may be performed similarly to training of the loss detection model 134. This time, measured channel loss metrics 112 may be used as training inputs 144-2 into equalization model 136. GT EQ parameters 116 may be used as target outputs 146-2. Determining GT EQ parameters 116 may be performed using any suitable equalization techniques, e.g., offline, and need not be subject to any time constraints. A difference 320 between generated EQ parameters 316 and GT EQ parameters 116 may be determined and evaluated using loss function 322. The computed value of loss function 322 may be used to adjust parameters of equalization model 136 in a direction that reduces the value of loss function 322. In the instances of an NN model used as equalization model 136, various techniques of backpropagation 324 and gradient descent may be used. Similarly, parameters of EQ model 136 may be adjusted in the instances where regression models, lookup tables, decision trees, SVMs, boosting classifiers, and/or the like, are used.

The trained loss detection model 134 and equalization model 136 may be deployed on computing devices and used for inference as disclosed in conjunction with FIG. 2.

FIG. 3B illustrates schematically another example training operations 320 of a unified machine learning model that may be deployed for fast and efficient equalization of signals transmitted over communication channels, according to at least one embodiment. More specifically, a unified MLM may be a combined loss/equalization model 330 that combines the functions of loss detection model 134 and EQ model 136 of FIG. 3A. Combined loss/equalization model 330 can have multiple output channels, e.g., estimated channel loss metrics 304 channel and EQ parameters 316 channel. The outputs of the respective channels can be compared with GT channel loss metrics 112 and GT EQ parameters 116 using respective loss functions 312 and 322 and then used to modify parameters of combined loss/equalization model 330.

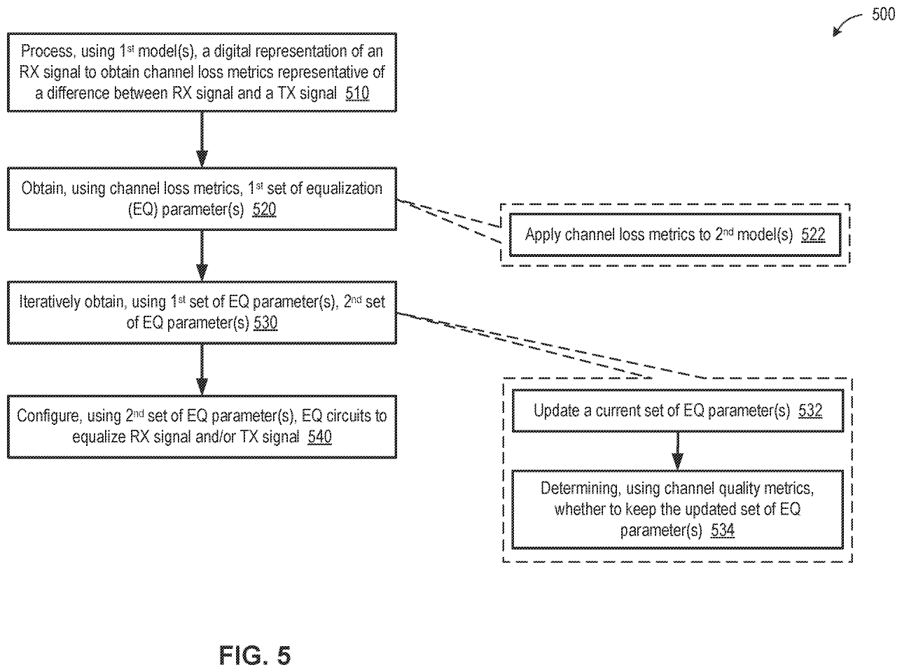

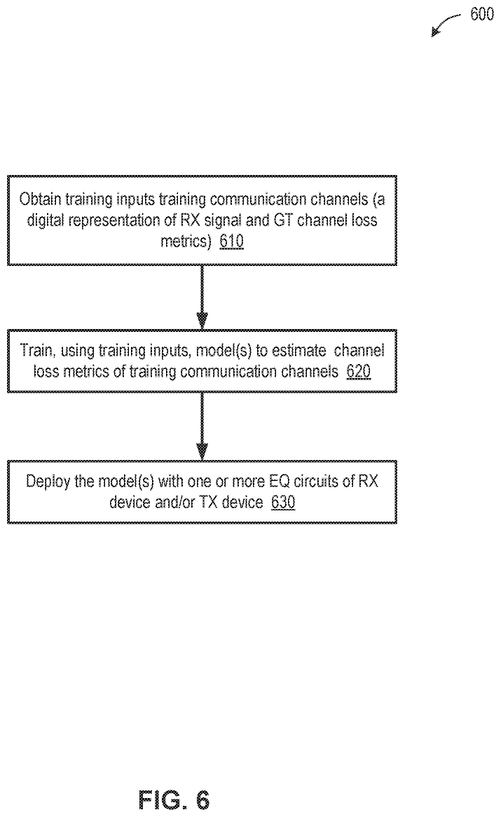

FIG. 5 and FIG. 6 are flow diagrams of example methods 500 and 600 of deploying and training machine learning models for fast and efficient equalization of signals transmitted over communication channels. Methods 500 and 600 may be performed in the context of autonomous driving applications, surveillance applications, manufacturing control applications, retail control applications, virtual reality or augmented reality services, chatbot applications, gaming applications, and many other contexts, as well as systems and applications for providing one or more of such services. Methods 500 and 600 may be performed using one or more processing units (e.g., CPUs, GPUs, accelerators, PPUs, DPUs, etc.), which may include (or communicate with) one or more memory devices. In at least one embodiment, methods 500 and 600 may be performed using various components and devices illustrated in FIG. 1, e.g., RX device 120, model training server 140, TX device 102, and/or the like. In at least one embodiment, processing units performing methods 500 and 600 may be executing instructions stored on non-transient computer-readable storage media. In at least one embodiment, methods 500 and 600 may be performed using multiple processing threads (e.g., CPU threads and/or GPU threads), individual threads executing one or more individual functions, routines, subroutines, or operations of the method. In at least one embodiment, processing threads implementing methods 500 and 600 may be synchronized (e.g., using semaphores, critical sections, and/or other thread synchronization mechanisms). Alternatively, processing threads implementing methods 500 and 600 may be executed asynchronously with respect to each other. Various operations of methods 500 and 600 may be performed in a different order compared with the order shown in FIG. 5 and FIG. 6. Some operations of method methods 500 and 600 may be performed concurrently with other operations. In at least one embodiment, one or more operations shown in FIG. 5 and FIG. 6 may not always be performed.

FIG. 5 is a flow diagram of an example method 500 of deploying machine learning models for fast and efficient equalization of signals transmitted over communication channels, according to at least one embodiment. At block 510, method 500 may include processing, using one or more first models (e.g., loss detection model(s) 134), a digital representation of an analog received (RX) signal (e.g., S_{R}(t), with reference to FIG. 2). The RX signal may be received via a communication channel (e.g., communication channel 202). The one or more first models may generate one or more channel loss metrics (e.g., channel loss metrics 252) representative of a difference between the RX signal and a TX signal (e.g., S_{T}(t) in FIG. 2). In some embodiments, the communication channel may include a coaxial cable, a wire cable, an optical fiber, and/or the like. In some embodiments, the one or more first models may include a neural network model 250. In some embodiments, the one or more first models may include a statistical model (e.g., statistical model 262). The digital representation of the RX signal may include data output by an ADC (e.g., ADC outputs 232). An input into the ADC may include the RX signal. In some embodiments, the statistical model may obtain the one or more channel loss metrics based at least on a ratio of a standard deviation of the data output by the ADC and a range of the data output by the ADC. In some embodiments, the one or more first models may be trained (e.g., using method 600 described below in conjunction with FIG. 6) to estimate the one or more channel loss metrics for a plurality of training communication channels.

At block 520, method 500 may continue with obtaining, using the one or more channel loss metrics, a first set of one or more equalization (EQ) parameters (e.g., an initial set of EQ parameters 222-I). In some embodiments, the one or more channel loss metrics may be representative of an amplitude difference between the TX signal and the RX signal at one or more frequencies. In some embodiments, the one or more channel loss metrics may be further representative of a phase difference between the TX signal and the RX signal at the one or more frequencies. In some embodiments, the one or more EQ parameters may include a gain for one or more frequencies, a phase change for the one or more frequencies, one or more pole frequencies, and/or other parameters.

In some embodiments, as illustrated with the callout block 522, obtaining the first set of the one or more EQ parameters may include applying the one or more channel loss metrics to one or more second models (e.g., EQ model 136). In some embodiments, the one or more second models may include a lookup table, a regression model, a neural network, a decision tree classifier, a boosting classifier, and/or the like.

At block 530, method 500 may include iteratively obtaining, using the first set of the one or more EQ parameters, a second set of one or more EQ parameters (e.g., a final set of EQ parameters 222-F). In some embodiments, iteratively obtaining the second set of one or more EQ parameters may include operations illustrated in the bottom callout portion of FIG. 5. The operations may be performed starting from the first set of the one or more EQ parameters. An individual iteration of the one or more iterations may include, at block 532, updating a current set of the one or more EQ parameters (e.g., a set of EQ parameters determined by the previous iteration). At block 532, the individual iteration may include determining, using one or more channel quality metrics representative of a signal quality of the RX signal, whether to keep the updated set of the one or more EQ parameters (or return to the EQ parameters of the previous iteration). In some embodiments, obtaining operations of block 534 may include obtaining one or more updated channel loss metrics for the updated set of the one or more EQ parameters and using the updated channel loss metrics to determine whether to keep the updated set of the one or more EQ parameters.

At block 540, method 500 may include configuring, using the second set of the one or more EQ parameters, one or more EQ circuits to equalize at least one of the RX signal, the TX signal, or a channel signal. The channel signal refers to the TX signal modified during propagation through at least a portion of the communication channel, e.g., a signal that represents any degree of evolution between the TX signal transmitted by a transmitting device and the RX signal received by the receiving device. The one or more EQ circuits may include one or more filters of a TX device (e.g., TX device 102 in FIG. 1) that generates the TX signal. The one or more EQ circuits may include one or more filters (e.g., EQ filters 220) of an RX device that receives the TX signal. The one or more EQ circuits may also include an input termination circuit of the RX device (e.g., input termination 210). In some embodiments, the one or more EQ circuits may include one or more channel filters 152 (with reference to FIG. 1) of the communication channel (e.g., in the instances of an active communication channel).

FIG. 6 is a flow diagram of an example method 600 of training machine learning models for fast and efficient equalization of signals transmitted over communication channels, according to at least one embodiment. At block 610, method 600 may include obtaining a plurality of training inputs. Individual training inputs of the plurality of training inputs may include a digital representation of an RX signal received via a respective training communication channel (e.g., training channel 302 in FIG. 3A and/or FIG. 3B) of a plurality of training communication channels. Individual training inputs may further include one or more ground truth (GT) channel loss metrics (e.g., channel loss metrics 112 in FIG. 3A and/or FIG. 3B) for the respective training communication channel. The one or more GT channel loss metrics may be representative of a difference between the RX signal and a TX signal transmitted via the respective training communication channel.

At block 620, method 600 may include training, using the plurality of training inputs, one or more models (e.g., loss detection model(s) 134) to estimate one or more channel loss metrics (e.g., estimated channel loss metrics 304) of the plurality of training communication channels. In some embodiments, the digital representation of the RX signal may include data output by an ADC (e.g., ADC 230). In some embodiments, the one or more models may include a neural network. In some embodiments, the one or more models may include a regression model that estimates the one or more channel loss metrics based at least on a ratio of a standard deviation of the data output by the ADC and a range of the data output by the ADC.

At block 630, method 600 may continue with causing the one or more trained models to be deployed in association with one or more equalization circuits of at least one of a RX device or a TX device communicating with the RX device via a communication channel.

### Inference and Training Logic

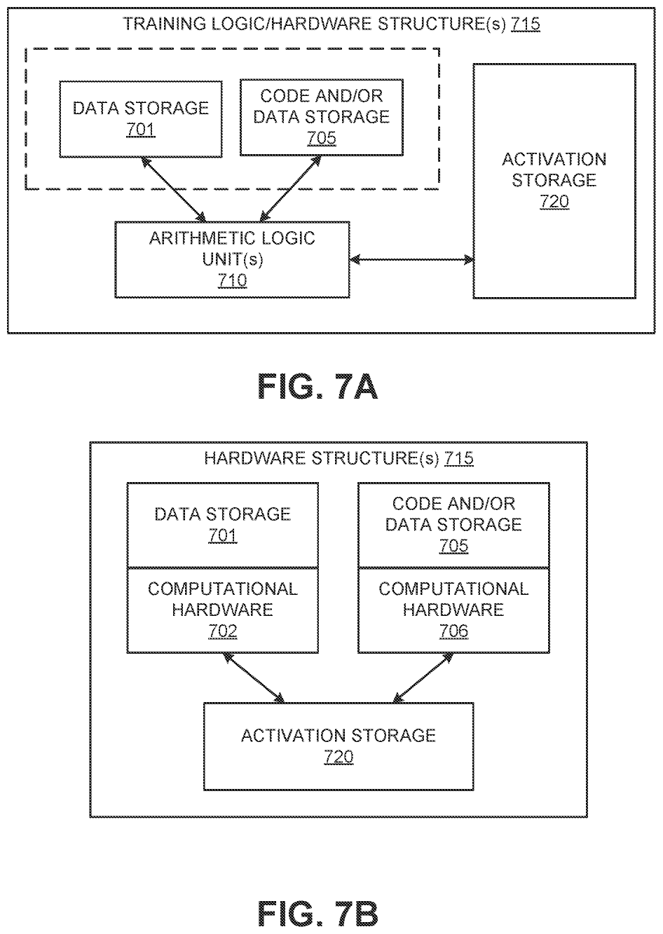

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include (or be coupled to code and/or data storage 701 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include (or be coupled to code and/or data storage 705 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, the result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

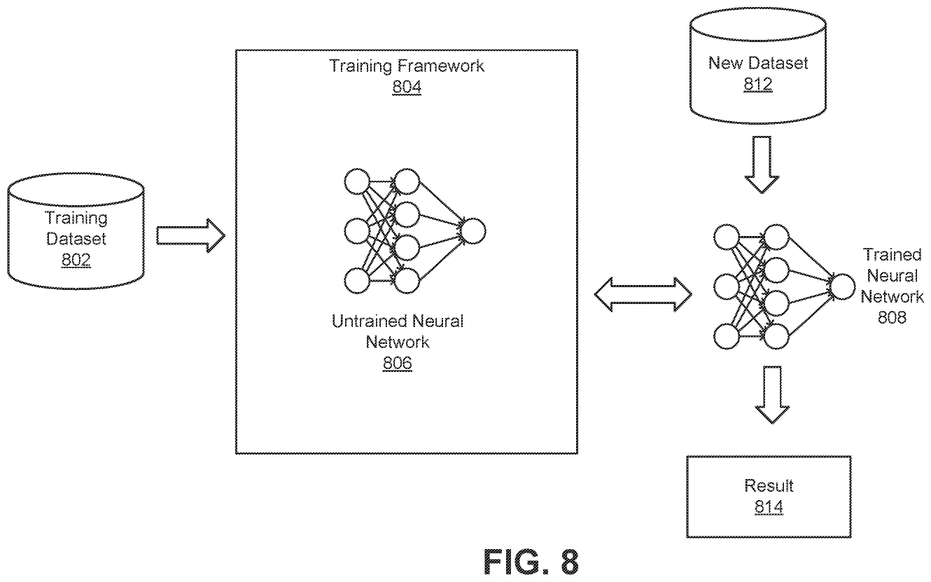

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

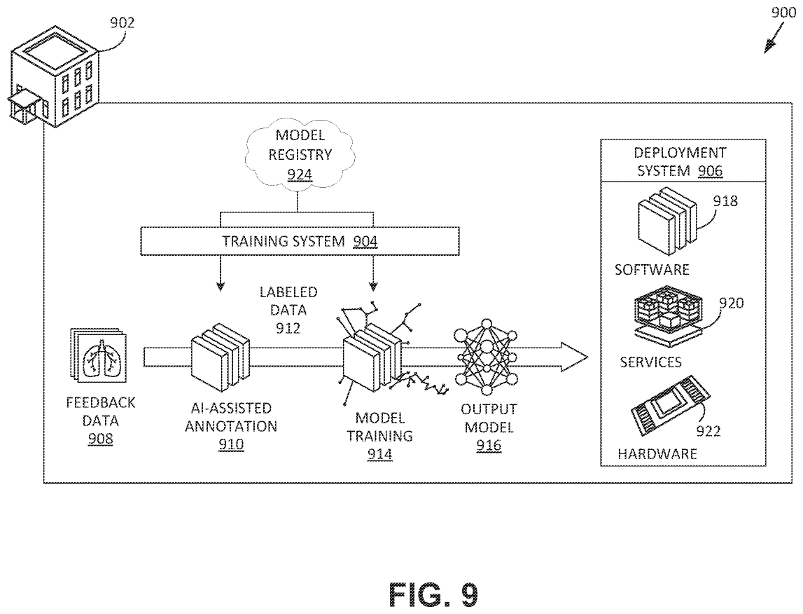

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

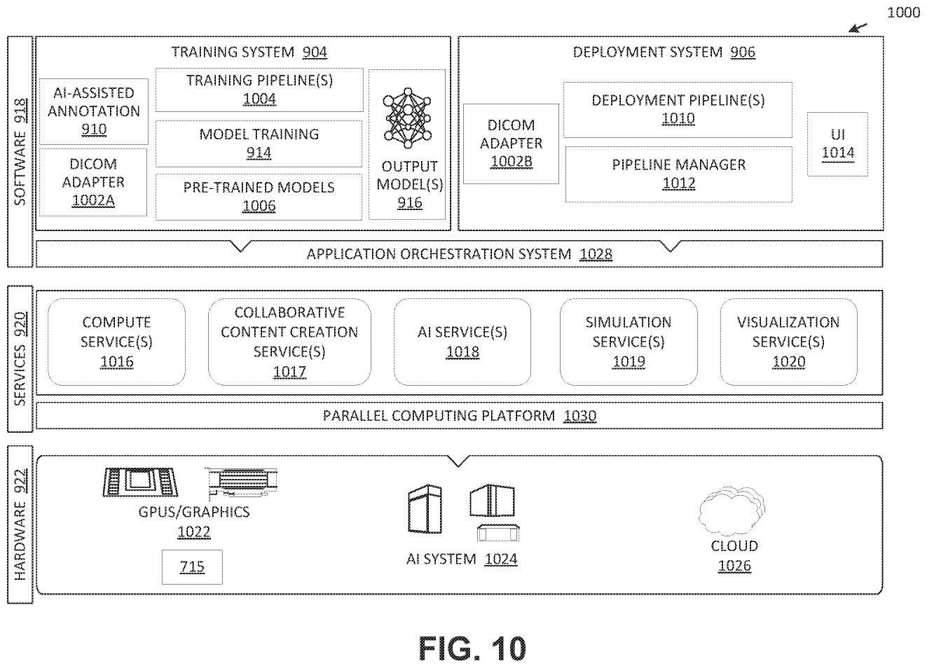

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914 may include data—e.g., AI-assisted annotations 910, labeled data 912, or a combination thereof—that may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers. In at least one embodiment, software 918 may include DICOM adapters 1002A and 1002B.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGXIM supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904 and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of the applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using one or more first models, a digital representation of an analog received (RX) signal received via a communication channel to obtain one or more channel loss metrics representative of a difference between the RX signal and a transmitted (TX) signal;
obtaining, using the one or more channel loss metrics, a first set of one or more equalization (EQ) parameters;
iteratively obtaining, using the first set of the one or more EQ parameters, a second set of one or more EQ parameters; and
configuring, using the second set of the one or more EQ parameters, one or more EQ circuits to equalize at least one of the RX signal, the TX signal, or a channel signal, wherein the channel signal comprises the TX signal modified during propagation through at least a portion of the communication channel.

2. The method of claim 1, wherein the communication channel comprises at least one of: a coaxial cable, a wire cable, or an optical fiber.

3. The method of claim 1, wherein the one or more channel loss metrics are representative of an amplitude difference between the TX signal and the RX signal at one or more frequencies.

4. The method of claim 3, wherein the one or more channel loss metrics are further representative of a phase difference between the TX signal and the RX signal at the one or more frequencies.

5. The method of claim 1, wherein the one or more first models comprise a neural network model.

6. The method of claim 1, wherein the one or more first models comprise a statistical model.

7. The method of claim 6, wherein the digital representation of the RX signal comprises data output by an analog-to-digital converter (ADC), wherein an input into the ADC comprises the RX signal, and wherein the statistical model obtains the one or more channel loss metrics based at least on a ratio of a standard deviation of the data output by the ADC and a range of the data output by the ADC.

8. The method of claim 1, wherein iteratively obtaining the second set of one or more EQ parameters comprises:
starting from the first set of the one or more EQ parameters, performing one or more iterations, wherein an individual iteration of the one or more iterations comprises:
updating a current set of the one or more EQ parameters; and
determining, using one or more channel quality metrics representative of a signal quality of the RX signal, whether to keep the updated set of the one or more EQ parameters.

9. The method of claim 1, wherein the one or more EQ parameters comprise:
a gain for one or more frequencies,
a phase change for the one or more frequencies, or
one or more pole frequencies.

10. The method of claim 1, wherein the one or more EQ circuits comprise one or more of:
one or more filters of a TX device, wherein the TX device generates the TX signal,
one or more filters of an RX device connected to the TX device via the communication channel, wherein the RX device receives the TX signal, or
an input termination circuit of the RX device.

11. The method of claim 1, wherein obtaining the first set of the one or more EQ parameters comprises:
applying the one or more channel loss metrics to one or more second models, wherein the one or more second models comprise at least one of:
a lookup table,
a regression model,
a neural network,
a decision tree classifier, or
a boosting classifier.

12. The method of claim 1, wherein the one or more first models are trained to estimate the one or more channel loss metrics for a plurality of training communication channels.

13. A method comprising:
obtaining a plurality of training inputs, wherein individual training inputs of the plurality of training inputs comprise:
a digital representation of a received (RX) signal received-via a respective training communication channel of a plurality of training communication channels, and
one or more ground truth (GT) channel loss metrics for the respective training communication channel, wherein the one or more GT channel loss metrics are representative of a difference between the RX signal and a transmitted (TX) signal transmitted via the respective training communication channel;
training, using the plurality of training inputs, one or more models to estimate one or more channel loss metrics of the plurality of training communication channels; and
causing the one or more trained models to be deployed in association with one or more equalization circuits of at least one of a RX device or a TX device communicating with the RX device via a communication channel.

14. The method of claim 13, wherein the plurality of training communication channels comprises at least one of: a coaxial cable, a wire cable, or an optical fiber.

15. The method of claim 13, wherein the digital representation of the RX signal comprises data output by an analog-to-digital converter (ADC), wherein an input into the ADC comprises the RX signal, and wherein the one or more models comprise at least one of:
a neural network, or
a regression model, wherein the regression model estimates the one or more channel loss metrics based at least on a ratio of a standard deviation of the data output by the ADC and a range of the data output by the ADC.

16. A processing device to:
process, using one or more first models, a digital representation of an analog received (RX) signal received via a communication channel to obtain one or more channel loss metrics representative of a difference between the RX signal and a transmitted (TX) signal;
obtain, using the one or more channel loss metrics, a first set of one or more equalization (EQ) parameters;
iteratively obtain, using the first set of the one or more EQ parameters, a second set of one or more EQ parameters; and
configure, using the second set of the one or more EQ parameters, one or more EQ circuits to equalize at least one of the RX signal, the TX signal, or a channel signal, wherein the channel signal comprises the TX signal modified during propagation through at least a portion of the communication channel.

17. The processing device of claim 16, to iteratively obtain the second set of one or more EQ parameters, the processing device is to:
perform, starting from the first set of the one or more EQ parameters, one or more iterations, wherein an individual iteration of the one or more iterations comprises:
updating a current set of the one or more EQ parameters; and
determining, using one or more channel quality metrics representative of a signal quality of the RX signal, whether to keep the updated set of the one or more EQ parameters.

18. The processing device of claim 16, wherein the one or more EQ parameters comprise:
a gain for one or more frequencies,
a phase change for the one or more frequencies, or
one or more pole frequencies.

19. The processing device of claim 16, wherein to obtain the first set of the one or more EQ parameters, the processing device is to:
apply the one or more channel loss metrics to one or more second models, wherein the one or more second models comprise at least one of:
a lookup table,
a regression model,
a neural network,
a decision tree classifier, or
a boosting classifier.

20. The processing device of claim 16, wherein the processing device is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of augmented reality content, virtual reality content, or mixed reality content;
a system implemented using a robot;
a system for performing conversational AI operations;
a system for generating synthetic data using AI operations;
a system incorporating one or more virtual machines (VMs);
a system implementing one or more language models;
a system implementing one or more large language models;
a system for performing one or more generative AI operations;
a system implemented at least partially in a data center; or
a system implemented at least partially using cloud computing resources.
